(19) United States
(12) Patent Application Publication
(10) Pub. No.: US 2017/0372280 A1
(43) Pub. Date: Dec. 28, 2017

(54) System and method for decoupling an e-commerce order from the electronic payment transaction

(71) Applicants: Kristóf EGEDY, Budapest (HU); Ádám Mónus, Budapest (HU); László TORDAI, Mucsony (HU)

(72) Inventors: Kristóf EGEDY, Budapest (HU); Ádám Mónus, Budapest (HU); László TORDAI, Mucsony (HU)

(21) Appl. No.: 15/190,733

(22) Filed: Jun. 23, 2016

(51) Int. Cl. G06Q 20/10; H04L 29/08; G06Q 20/34

(52) U.S. Cl. CPC G06Q 20/102; G06Q 20/34; H04L 67/02

(57) ABSTRACT

A method or system for facilitating financial transactions, in particular, an electronic payment method for managing payment of a cost of a consumer's e-commerce order separately from the purchase transaction. The invention thereby decouples the role of the customer—who sets up the e-commerce order—from the role of the paying party. Thus the e-commerce transaction can be completed by the consumer without paying for the goods or service selected in the e-commerce transaction. The electronic payment for the selected goods or services may be made externally in a separate web application at any later time within a preset time limit by any number of persons who is/are identified by the consumer as a paying or paying parties in the e-commerce transaction.

### FIELD OF THE INVENTION

The present invention relates generally to facilitating financial transactions, and more specifically, to an electronic payment method for managing payment of a cost of a consumer's e-commerce order separately from the purchase transaction.

### BACKGROUND OF THE INVENTION

A common feature of currently used real-time payment procedures in the online purchase application is that the payment transaction is to be carried out by the consumer in a special session of the browsing application running on the consumer's device, which typically includes a PC, a laptop, a tablet or a smart phone. In those situations where someone else is requested to pay for the consumer's purchase in an e-commerce transaction, details of the bank card (e.g. debit card, credit card, etc.) of the paying party should be made available for the customer (i.e. the purchasing party) so that the customer is able to conclude the electronic payment transaction as a final step of the e-commerce transaction. Alternatively, the consumer should hand over the purchase details to the paying party, and subsequently the paying party itself has to separately enter the e-commerce application, to select the product(s) again and then to manage the electronic payment transaction by using his or her bank card. These procedures are rather inconvenient for both of the consumer and the paying party.

The above issue seems to be even more complicated when more than one paying parties should be involved in the electronic payment transaction to arrange the payment for a product selected by a consumer in an e-commerce transaction.

One possible solution of the above mentioned payment problem is disclosed in the document US 2002/0103753 A1, which describes a method for splitting the costs of goods and services among multiple payment sources without undue burden to the consumer or vendor. In that method the consumer is prompted at the time of purchase to designate if the cost will be split among multiple payment sources, then the number of the sources that will be used to pay for said cost is determined. It is followed by receiving information necessary for validation of said sources, and the validation information is transmitted for processing to at least one online payment verification service, which returns validation status of said sources. When the cost of a consumer purchase is split between different consumers, the payment source information of the primary customer is received at purchase initiation. Finally the validation status is processed, whereby if validation was successful, the consumer is allowed to finalize the transaction, however if the validation was unsuccessful for at least one said source, then the consumer is presented with a number of options that would allow the consumer to successfully conclude the transaction. This method has the drawback that there is a primary customer who also must initiate purchase and must participate in payment. Therefore, it cannot be used to completely decouple the customer from the paying party. The method's other drawback is that specific information of the payment sources, like bank card data (e.g. name of the card holder, card number, card expiry date, etc.) must be received to finalize the purchase transaction of the consumer.

It is an objective of this present invention to provide an electronic payment system and electronic payment methods that allow a convenient and secure electronic payment separately from the e-commerce session and thereby completely decouples the role of the customer—who sets up the e-commerce order—from the role of the paying party. To achieve this objective in the most secure way this present invention does not need to receive sensitive details (e.g. bank card data) of the payment sources to finalize the purchase transaction of the consumer.

### SUMMARY OF THE INVENTION

These and other objectives are achieved by providing a method for managing payment of a cost of a consumer's purchase in an e-commerce transaction managed by a merchant's web application, the method comprising the steps of:
a) from the e-commerce transaction, receiving a request for an external payment of said cost, said request containing at least an identifier of the consumer, the cost of the purchase and a merchant transaction ID,
b) generating a unique non-guessable payment URL of an external payment management application,
c) associating an external payment ID with said payment URL,
d) providing the payment URL to at least one paying party on a user device by means of an interaction with the consumer,
e) once a paying party has activated said payment URL on a user device, receiving an URL activation message from the user device, and displaying a first screen on the user device, said first screen showing at least an identifier of the consumer, the cost of the purchase and an option for initiating an electronic payment transaction in an electronic payment system;
f) once a paying party has initiated an electronic payment transaction, receiving a payment activation message, sending an electronic payment request to the electronic payment system,
g) once the electronic payment transaction has been concluded, receiving information on the result of the electronic payment transaction from the electronic payment system,
h) notifying the contributing paying party about the result of the electronic payment transaction,
i) if within a time limit the electronic payment transaction of at least one paying party has been successfully concluded and the accumulated payment of at least one paying party covers said entire cost, then finishing the external payment transaction as a successful external payment,
   otherwise finishing the external payment transaction as a failed external payment,
j) notifying the merchant of the result of the external payment.

The merchant transaction ID may be associated with the payment URL as an external payment ID.

In a preferred embodiment of the method, in step c), a new external payment ID may be generated, and it may be sent back to the e-commerce transaction.

In a preferred embodiment of the method, step d) comprises the steps of:
re-directing the consumer to the payment URL,
displaying a second screen for the consumer, said second screen being configured to receive payment-related information from the consumer;
on said second screen,
   prompting the consumer to enter at least one of an e-mail address, a social media address and a mobile phone number of at least one paying party,
   prompting the consumer to activate a function of sending the payment URL to the at least one paying party addressed on the second screen, and
in response to the activation of the function of sending the payment URL, automatically sending at least one of an email, a social media message and a mobile phone message including said external payment URL to the at least one paying party.

In an alternative embodiment of the method, step d) comprises the steps of:
re-directing the consumer to the payment URL,
displaying a third screen for the consumer, said third screen showing the external payment URL, thereby allowing the consumer to send the payment URL to at least one paying party via at least one of an email, a social media message and mobile phone message.

Preferably, after step a) and before step d), the method further comprises the steps of:
re-directing the consumer to the payment URL,
displaying a fourth screen for the consumer, said fourth screen being configured to receive at least one of the following items of payment-related information from the consumer:
i) number of the paying parties;
ii) in case of multiple paying parties, indication on whether the cost is to be split evenly among the paying parties or the cost is to be split by the consumer uniquely,
iii) in case of unique split of the cost, the amount to be paid by each one of the paying parties,
on said fourth screen, prompting the consumer to input said payment-related information items, and
in response to receiving said payment-related information items, in step e) the respective amount to be paid is additionally displayed for the paying party on the first screen.

In a preferred embodiment of the method, in step e), on the first screen at least one of the following items may be also displayed: purchase details, time limit or remaining time for contributing to the external payment, name of the consumer, current balance of the external payment.

Preferably, after step h), the method further comprises a step of notifying the consumer about the success of the electronic payment transaction of any one of the contributing paying parties.

The above and other objects are also achieved by providing a non-transitory data storage medium comprising a set of computer-readable instructions, said instructions being adapted, when executed by one or more computers, to carry out the steps of the above method.

### BRIEF DESCRIPTION OF THE DRAWINGS

FIG. 1 is a communication diagram showing the information exchange between the entities of the electronic payment system in a method according to a first embodiment of the invention.

FIG. 2 is a flow diagram showing the main steps of the method according to the first embodiment of the invention.

FIGS. 3A to 3F are illustrations of various screens of the external payment website when carrying out the method according to the first embodiment of the invention.

FIGS. 4 to 6 are flow diagrams showing the additional steps of various preferred embodiments of the method of the invention.

### DETAILED DESCRIPTION OF THE PREFERRED EMBODIMENTS

The method of the present invention is associated with an e-commerce transaction, in particular with a purchase transaction in a merchant's web shop, which typically offers goods or services for consumers. Furthermore, the e-commerce transaction may be a part of any other kind of web application in which electronic payment through an electronic online payment system is available. Such a web application may, for example, include an online customer service of a utility provider or any other service provider, like a travel agency, an entertainment company (e.g. cinemas, theatres, concert halls, museums, etc.) or any other sort of institution, organization or business entity that offers goods and/or services through the internet. All of these commerce entities are herein referred to as “merchant”.

The core idea of the method of the present invention is that the electronic payment transaction through an electronic payment system is separated from the session of the e-commerce transaction, i.e. the e-commerce transaction can be completed by the consumer without paying for the goods or service selected in the e-commerce transaction. The electronic payment for the selected goods or services may be paid in a separate web application at any later time within a preset time limit by any number of persons who is/are identified by the consumer as a paying or paying parties in the e-commerce transaction. It is noted that one of the selected paying parties may even be the consumer itself. In specific case, the consumer himself or herself may be the single paying party who can conclude the electronic payment transaction either on the same computer device (e.g. desktop PC, laptop, notebook, etc.) on which the e-commerce application is running or on any other internet-capable device like a smart phone or a tablet.

As the effective electronic payment transaction is separated from the e-commerce transaction, it is regarded as an external payment with respect to the e-commerce transaction. Therefore within the context of the present invention, the term “external payment” and “external payment transaction” are to be meant as an electronic payment method that is managed by a web application which is independent of the e-commerce web application. The external payment method may use any kind of electronic payment system, such as the electronic payment application of a bank or any other financial institute, bank card, wire transfer, e-wallet (PayPal, Skrill, etc.) or any form of e-money etc. The external payment transaction thus forms a part of the overall payment procedure, which starts with the activation of the option of external payment within the e-commerce transaction (after the goods or services to be purchased have been selected by the consumer), and terminates with the completion of the electronic payment transaction through an electronic payment system and the transmission of a notification to the merchant of the purchased goods or services about the status of the external payment transaction.

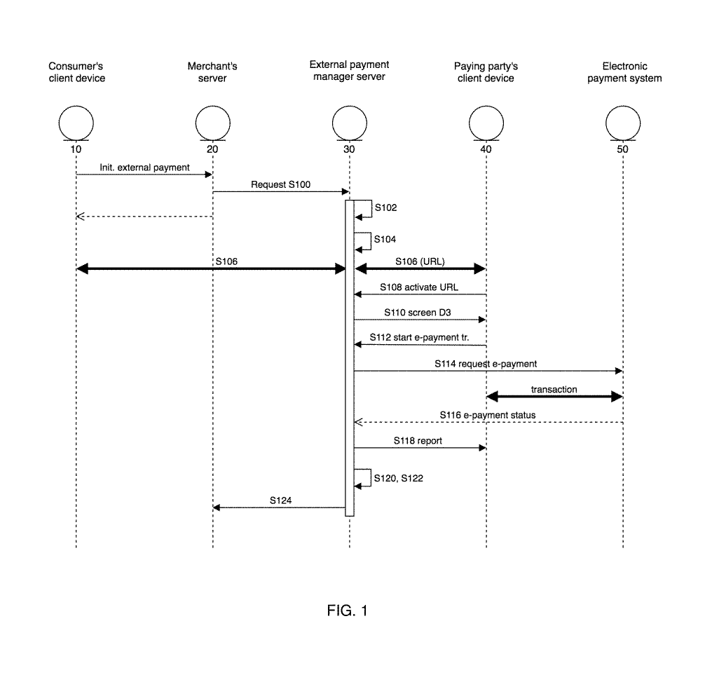

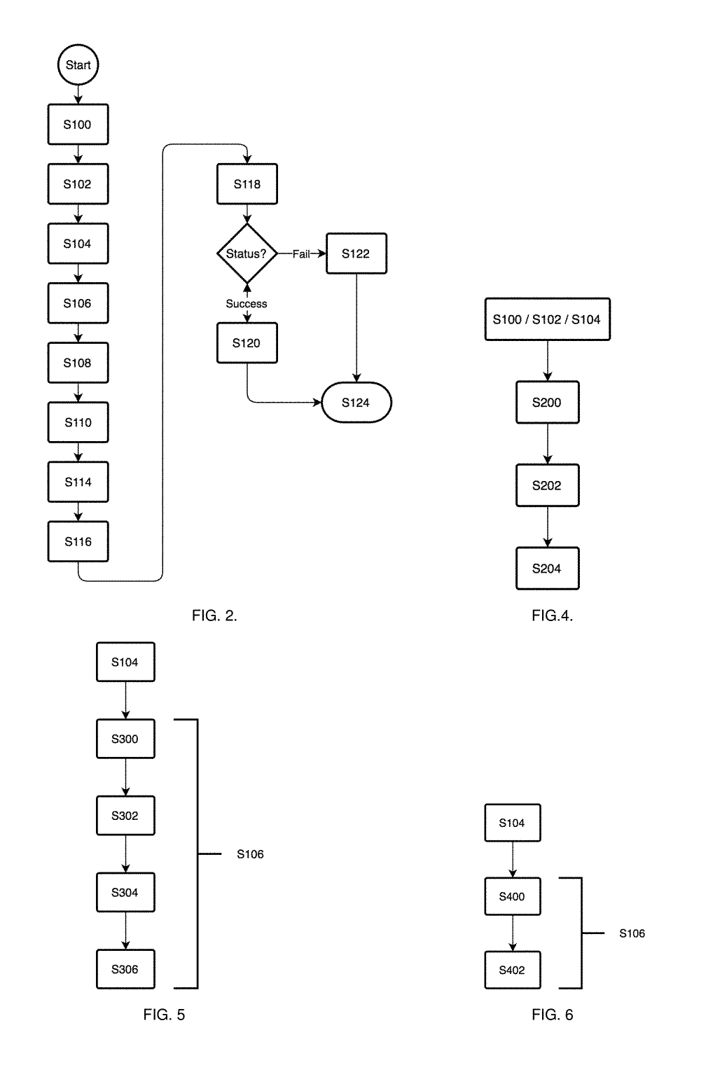

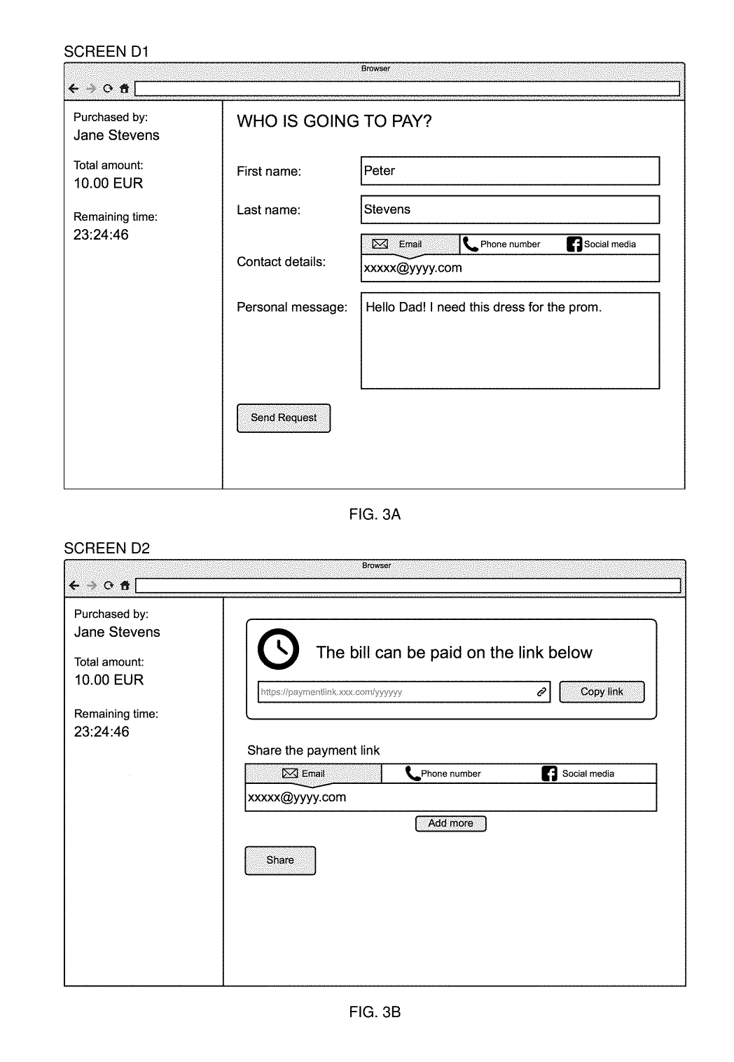

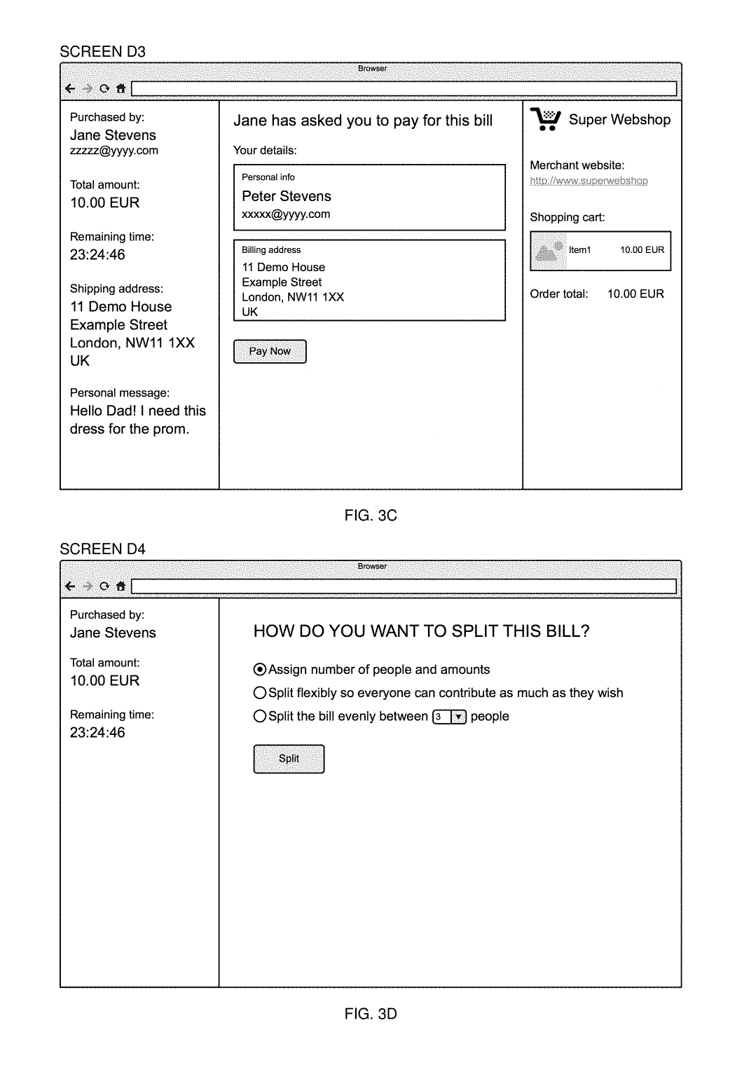

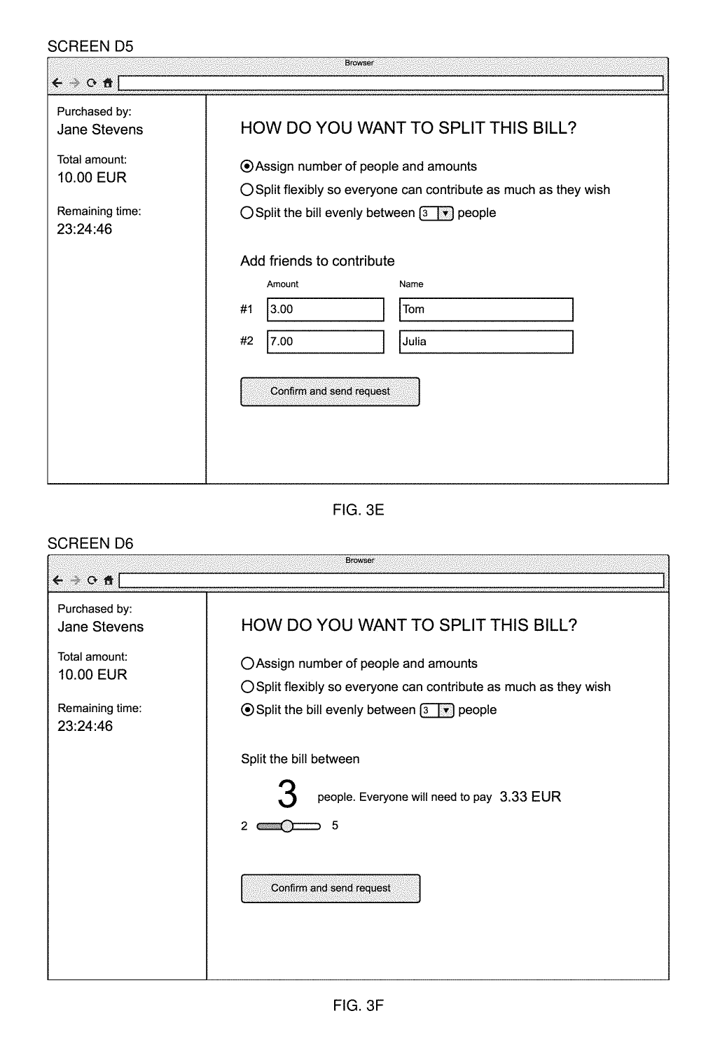

With reference to FIGS. 1 to 3F, a first embodiment of the method according to the present invention will now be described in detail, wherein FIG. 1 illustrates a communication diagram showing the information exchange between the entities of the overall payment scheme in a method of the invention, FIG. 2 is a flow diagram showing the main steps of the method of the invention and FIGS. 3A to 3F are illustrations of various screens of the external payment management application when carrying out the method of the invention.

After the consumer has selected goods or services to be purchased, the payment procedure is initiated by the consumer through activating the option of external payment in the e-commerce transaction, e.g. in a merchant's web shop. In this initial step the consumer activates a corresponding element, like a menu option, a button or a link, in the e-commerce application by clicking on said activating element, thereby the browser application running on the consumer's device 10 sends an appropriate message to the merchant's e-commerce application running on a server 20 hosting the merchant's e-commerce application (also referred to as merchant server 20).

Upon receiving the external payment activation message from the consumer, the e-commerce application generates a request for the external payment, which is then sent from the merchant server 20 to an external payment management application hosted by a payment server 30. In step S100 of the payment method, the payment server 30 receives a request for the external payment from the e-commerce transaction. The request shall contain at least an identifier of the consumer, the cost of the purchase to be paid and a merchant transaction ID.

The consumer's identifier may be any form of identification that is typically generated by the e-commerce application. This identifier may for example include the name of the consumer, a unique code associated with the consumer within the particular e-commerce transaction, or any other identifier that allows an unambiguous identification of the consumer in the payment procedure.

In step S102 the external payment management application generates a unique non-guessable URL of an external payment web site (also referred to as a payment URL) that will be used to inform the one or more paying parties about the status of the external payment and to allow the one or more paying parties to effectuate an external payment transaction through an electronic payment system.

In step S104 an external payment ID is associated with said payment URL. The external payment ID is used to identify the particular payment transaction by the external payment management application. The external payment ID may be the transaction ID provided by the e-commerce application of the merchant or alternatively, a new unique identification code may also be generated by the external payment management application itself.

In the next step S106, the external payment URL is made available for at least one paying party on a user device 40 thereof. This step of the method can be implemented in several ways. For example, the payment URL may be sent to a paying party automatically in an e-mail message, a mobile phone message or a social media message when the consumer specifies an email address, a mobile phone number or a social media address, respectively, of the paying party in the external payment management application.

Another option may be that the payment URL is displayed to the consumer by the external payment management application and the consumer himself/herself sends the payment URL to at least one paying party in a separate e-mail, social media message or mobile phone message.

When a paying party receives a message from the external payment management application with a payment request originating from the consumer, the paying party should decide whether or not to contribute to the payment of the cost of the goods or services selected by the consumer. When a paying party decides to contribute to the payment, the paying party has to activate the payment URL on a user device. The user device on which the payment URL is activated may be the same device by which the paying party has received the message containing the payment URL, or it may be any other internet-capable device that can run a browser or an application allowing the activation of the payment URL. In the first case the paying party may simply click on the URL within the received message to open the URL or the paying party may first open a browser application and then type the URL in the corresponding field of the application displayed on the same device. In the latter case, however, the paying party has to open a browser or an application in another internet-capable device, such as a computer, and then the paying party has to enter the payment URL in the corresponding field of the browser application or an application displayed on said other device. By presenting the URL to the paying party, the paying party is prompted to activate the URL and to contribute to the payment of the cost required by the consumer.

When the paying party has activated the payment URL on a user device, in step S108 a corresponding URL activation command is received by the external payment management application. Once the URL activation command is received, the external payment management application displays a screen D3 on the device 40 used by the paying party in step S110. This screen D3 shows at least an identifier of the consumer, the cost of the purchase and an option for initiating an electronic payment transaction through an electronic payment system. Optionally, further information relating to the external payment transaction, like additional sale information on the goods or service to be purchased, the time limit (e.g. date and time) or the remaining time (e.g. in hours) for contributing to the external payment, name of the consumer, current balance of the external payment, etc. may also be shown in the screen D3. An illustration of this screen D3 is shown in FIG. 3C as an example.

On the screen D3 the paying party is prompted to initiate an electronic payment transaction through an electronic payment system. The paying party may initiate the electronic payment transaction by activating the corresponding element, e.g. menu option, button, link, etc, on the screen D3. Once the paying party activated the electronic payment function on his or her user device, a corresponding activation command is sent from the user device 40 to the external payment management application, which receives this command in step S112. From this point of the payment procedure, the paying party, who has initiated an electronic payment transaction, will be regarded as a contributing paying party within the context of the present invention.

Next, in step S114, the external payment management application sends an electronic payment request to an electronic payment system 50 through which the contributing paying party can pay a portion or the full amount of the cost. In this electronic payment transaction, an account of the contributing paying party will be debited or the cost will be authorized. The account of the contributing paying party in the electronic payment system 50 is a monetary account (e.g. a bank account, bank card or any other account that handles money.)

In a preferred embodiment of the method of the invention, in the screen D3 multiple electronic payment systems (not shown in FIG. 3C) may be offered in which the electronic payment transaction can be concluded and the paying party is allowed to select any one of the optional electronic payment systems shown on screen D3.

After the contributing paying party has initiated the electronic payment transaction in step S114, a number of common transaction steps are carried out by the electronic payment system. These steps include, for example, displaying a form requesting account or bank card details from the contributing paying party, requesting confirmation of the transaction data given by the paying party, displaying a form requesting a security code from the contributing paying party, displaying status information about the electronic payment transaction, e.g. successful payment, failed transaction, etc. These common actions of an electronic payment transaction are not specific to the method of the invention, therefore the detailed description thereof is omitted.

Once the electronic payment transaction has been completed, the external payment management application receives information on the result of the electronic payment transaction from the electronic payment system in step S116, and notifies the contributing paying party about the result, i.e. success or failure, of the electronic payment transaction in step S118.

If within a preset time limit the electronic payment transaction of at least one paying party has been successfully concluded and the accumulated payment of the at least one paying party covers said cost, then the external payment transaction is finished as a successful external payment in step S120, otherwise the external payment transaction is finished as a failed external payment in step S122.

Finally, in step S124 the merchant is notified of the result of the external payment, thereby ending the external payment procedure.

The aforementioned time limit is preferably set to a reasonably long time to allow the paying parties to conveniently take part in the external payment process. This time limit may, for example, be a period extending from a few hours to a few days, while in specific applications (e.g. in a web shop offering wedding presents with a high number of contributing paying parties), a time limit of a couple of weeks or even more might be set.

In case the external payment procedure terminated with failure, i.e. the total amount of the cost was not collected within the time limit, but at least one paying party successfully completed his or her electronic payment transaction, the contribution of the at least one paying party should be refunded by the merchant. How the mechanism of this refund process is configured is beyond the scope of the present invention and therefore not dealt with herein.

In a preferred embodiment of the method of the invention, the external payment management application may be configured to allow for a paying party to contribute to the external payment any number of times within the time limit by paying only a portion of his or her total contribution at a time.

In a preferred embodiment of the method of the invention, after receiving the request for the external payment from the e-commerce transaction in step S100 (but before the external payment URL is made available for the at least one paying party in step S106), the consumer is re-directed to the payment URL in step S200 as shown in FIG. 4. At the payment URL a screen D4 is displayed, in step S202, for the consumer to input at least one of the following items of payment-related information by the consumer:
i) number of paying parties;
ii) in case of multiple paying parties, an indication as to whether the cost is to be split evenly among the paying parties or the cost is to be arbitrarily split by the consumer,
iii) in case of arbitrary split of the cost, the amount to be paid by each one of the paying parties.

An illustration of the screen D4 can be seen in FIG. 3D as an example.

On screen D4, the consumer is prompted to input at least one of said payment-related data. When the consumer selects the option of arbitrary splitting the cost, the amount to be paid by each one of the paying parties may have a default value, which is preferably the same value for each of the paying parties as displayed on screen D6 shown in FIG. 3F, for example. In this case, the consumer may modify any one of the amounts so that the total cost should remain unchanged. Alternatively, there is no default value shown with respect to the multiple paying parties and the consumer is prompted to type the required amounts for each of the paying parties as displayed on screen D5 shown in FIG. 3E, for example.

After the consumer filled in the required fields of the forms of the screens D4 to D6 and the external payment management application received the submitted data in step S204, the collected information is processed by the external payment management application and as a result, the respective amount to be paid (i.e. the amount of contribution) may be also displayed for the paying party on screen D3 in step S110 after the activation of the payment URL on the user device.

In an alternative embodiment of the method of the invention, only the number of the paying parties is specified by the consumer and each of the paying parties can contribute to the external payment by any amount, i.e. no specific amount to be paid by at least one paying party is pre-defined. In this case, a notice may be displayed on the screen D3 for the contributing paying party, said notice informing the paying party on the possibility of paying any amount freely (up to the total cost of the purchase).

In a preferred embodiment of the method of the invention, overpayment of the cost by one or more contributing paying parties may be processed in the following way. Overpayment occurs when more money is altogether paid by the contributing paying parties than the purchase cost. One option may be to refund the same amount of the excessive cost to each paying party. Another option may be to refund an amount to a paying party proportionally to his or her actual payment.

In a preferred embodiment of the method of the invention, as already mentioned above, right before the payment URL is made available for at least one paying party in step S106, the consumer is re-directed to the payment URL in step S300 as shown in FIG. 5. At the payment URL a screen D1 is displayed, in step S302, with a form to be filled in by the consumer. The fields of the screen D1 allow the consumer to specify at least one of an e-mail address, a social media address and a mobile phone number of at least one paying party. An illustration of the screen D1 can be seen in FIG. 3A as an example.

After the consumer filled in the form of screen D1, the consumer is prompted to send the payment URL to the at least one paying party addressed on this screen D1. Upon the consumer's activation of the function of sending the payment URL in step S304, at least one of an email, a social media message and a mobile phone message containing said payment URL will be automatically sent to at least one paying party in step S306. In this scheme the payment URL is directly sent from the external payment management application to a user device of a paying party in the above mentioned step S106 of the method.

In another preferred embodiment of the method of the invention as also mentioned above, right before the external payment URL is made available for at least one paying party in step S106, the consumer may be re-directed to the payment URL in step S400 as shown in FIG. 6. At the payment URL a screen D2 is displayed, in step S402, optionally with a form to be filled in by the consumer. An illustration of the screen D2 can be seen in FIG. 3B as an example. This screen D2 presents the payment URL to the consumer, thereby allowing the consumer to send the payment URL by himself/herself to at least one paying party via at least one of an email, a social media message and mobile phone message. In this scheme the payment URL is indirectly sent from the external payment management application to a user device of a paying party with the participation of the consumer in the above mentioned step S106 of the method.

In another preferred embodiment of the method of the invention, after an electronic payment transaction of a contributing paying party has been successfully completed and the external payment management application has received information on the positive result of the electronic payment transaction from the electronic payment system in step S116, the external payment management application may also notify the consumer about the success of the electronic payment transaction of the given contributing paying party. This notification may be sent in any one of an e-mail, a social media message and a mobile phone message.

After the time limit of the external payment has expired, the merchant is notified of the result of the external payment transaction. When the external payment was successful, the merchant may take the necessary steps to deliver the purchased goods to the consumer or to provide the purchased services for the consumer. However, in case of a failed external payment transaction, the order of the consumer may be cancelled in the e-commerce transaction, preferably followed by a respective notification of the consumer.

In a second aspect, the present invention relates to a non-transitory data storage medium comprising a set of computer-readable instructions, said instructions being adapted, when executed by one or more computers, to carry out the steps of the method of the invention.

It will be understood that the preferred embodiments of the present invention described above have been disclosed by way of example and that other modifications and alterations may occur to those skilled in the art without departing the scope and spirit of the appended claims.

1. A method for managing payment of a cost of a consumer's purchase in an e-commerce transaction managed by a merchant's web application, the method comprising the steps of:
a) from the e-commerce transaction, receiving a request for an external payment of said cost, said request containing at least an identifier of the consumer, the cost of the purchase and a merchant transaction ID,
b) generating a unique non-guessable payment URL of an external payment management application,
c) associating an external payment ID with said payment URL,
d) providing the payment URL to at least one paying party on a user device by means of an interaction with the consumer,
e) once a paying party has activated said payment URL on a user device, receiving an URL activation message from the user device, and displaying a first screen on the user device, said first screen showing at least an identifier of the consumer, the cost of the purchase and an option for initiating an electronic payment transaction in an electronic payment system;
f) once a paying party has initiated an electronic payment transaction, receiving a payment activation message, sending an electronic payment request to the electronic payment system,
g) once the electronic payment transaction has been concluded, receiving information on the result of the electronic payment transaction from the electronic payment system,
h) notifying the contributing paying party about the result of the electronic payment transaction,
i) if within a time limit the electronic payment transaction of at least one paying party has been successfully concluded and the accumulated payment of the at least one paying party covers said entire cost, then finishing the external payment transaction as a successful external payment,
otherwise finishing the external payment transaction as a failed external payment,
j) notifying the merchant about the result of the external payment.

2. The method of claim 1, wherein in step c) the merchant transaction ID is associated with the payment URL as an external payment ID.

3. The method of claim 1, wherein
in step c), a new external payment ID is generated, and
the method further comprises the step of forwarding the generated external payment ID to the e-commerce transaction.

4. The method of claim 1, wherein step d) comprising the steps of:
re-directing the consumer to the payment URL,
displaying a second screen for the consumer, said second screen being configured to receive payment-related information from the consumer;
on said second screen,
prompting the consumer to enter at least one of an e-mail address, a social media address and a mobile phone number of at least one paying party,
prompting the consumer to activate a function of sending the payment URL to at least one paying party addressed on the second screen, and
in response to the activation of the function of sending the payment URL, automatically sending at least one of an email, a social media message and a mobile phone message including said external payment URL to at least one paying party.

5. The method of claim 1, wherein step d) comprising the steps of:
re-directing the consumer to the payment URL,
displaying a third screen for the consumer, said third screen showing the external payment URL, thereby allowing the consumer to send the payment URL to at least one paying party via at least one of an email, a social media message and mobile phone message.

6. The method of claim 1, wherein after step a) and before step d), the method further comprising the steps of:
re-directing the consumer to the payment URL,
displaying a fourth screen for the consumer, said fourth screen being configured to receive at least one of the following items of payment-related information from the consumer:
i) number of the paying parties;
ii) in case of multiple paying parties, indication on whether the cost is to be split evenly among the paying parties or the cost is to be split by the consumer uniquely,
iii) in case of unique split of the cost, the amount to be paid by each one of the paying parties,
on said fourth screen, prompting the consumer to input said payment-related information items, and
in response to receiving said payment-related information items, in step e) the respective amount to be paid is additionally displayed for the paying party on the first screen.

7. The method of claim 1, wherein in step e), on the first screen further displaying at least one of the following items: purchase details, time limit or remaining time for contributing to the external payment, name of the consumer, current balance of the external payment.

8. The method of claim 1, wherein after step h), the method further comprises a step of notifying the consumer about the success of the electronic payment transaction of any one of the contributing paying parties.

9. A non-transitory data storage medium comprising a set of computer-readable instructions, said instructions being adapted, when executed by one or more computers, to carry out the steps of the method of claim 1.
